(19) United States
(12) Patent Application Publication
(10) Pub. No.: US 2007/0161309 A1
(43) Pub. Date: Jul. 12, 2007

(54) Nonwoven substrate

(76) Inventor: David Villeneuve, Bedford, NH (US)

Correspondence Address: Todd A. Sullivan;Hayes Soloway, 175 Canal Street, Manchester, NH, 03101, US

(21) Appl. No.: 11/326,798

(22) Filed: Jan. 6, 2006

(51) Int. Cl. B32B 27/04

(52) U.S. Cl. 442/149

(57) ABSTRACT

A plurality of staple fibers and a plurality of binder fibers are substantially homogeneously mixed. The binder fibers include polyphenylene sulfide. The mixed fibers are heat pressed to form at least one sheet of nonwoven substrate. The nonwoven substrate is made up of at least 5 wt. % of staple fibers and at least 5 wt. % of binder fibers.

### TECHNICAL FIELD

The present invention is generally related to the field of nonwoven substrate, and particularly related to nonwoven substrate made of staple fibers and binder fibers.

### BACKGROUND OF THE INVENTION

Polyphenylene sulfide (PPS) is a high temperature engineering thermoplastic. Articles made of PPS may contain reinforcements. PPS is durable and resistive to chemical degradation over a wide range of temperatures. PPS is commonly used in making high temperature electronic, automotive and industrial components as well as filters for dust filtration chambers, particularly where the filters have some risk of chemical exposure.

Worldwide, some estimates suggest PPS fiber demand is approximately eleven hundred tons per year and is growing. PPS is a good choice for use in harsh environments having high temperatures and corrosive atmospheres, such as baghouse and flue gas filters in coal-fired boilers, cogeneration units and cement kilns. PPS is also used in liquid filtration, especially in harsh environments, such as in the auto, chemical, electrical, petrochemical, pharmaceutical, food, and beverage industries.

PPS has very good electrical insulation characteristics. Dielectric strength and constant, thermal conductivity, dissipation, and flame retardance are better than or equal to other thermoplastics considered standard in the electrical industry. While PPS is a good material for manufacturing electrical insulation and filters, based in part on its chemical and thermal durability, PPS does have some drawbacks. PPS lacks the mechanical or tensile strength of other fibers used for the same applications, leaving it prone to mechanical damage. PPS is also fairly expensive. PPS can cost as much as nine dollars per pound, when purchased in bulk fiber, which still needs to be processed to construct a filter. Some manufacturers use a filler to manufacture PPS-based filters more cost effectively.

Thus, a heretofore unaddressed need exists in the industry to deal with the aforementioned deficiencies and inadequacies.

### SUMMARY OF THE INVENTION

Embodiments of the present invention provide a system and method for providing a substrate. Briefly described, in architecture, one embodiment of the system, among others, can be implemented as follows. A nonwoven substrate is made up of at least 5 percent by weight (wt. %) of staple fibers and at least 5 wt. % of binder fibers substantially homogeneously mixed with the staple fibers. Further, the binder fibers include polyphenylene sulfide.

The present invention can also be viewed as providing methods for providing a substrate. In this regard, one embodiment of such a method, among others, can be broadly summarized by the following steps: substantially homogeneously mixing a plurality of at least 5 wt. % staple fibers and a plurality of at least 5 wt. % binder fibers, wherein the binder fibers include polyphenylene sulfide; and heat pressing the combed binder fibers and staple fibers, thereby forming a substrate sheet.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 shows a microscale side view of a nonwoven substrate, in accordance with a first exemplary embodiment of the invention.

FIG. 2 shows a microscale side view of a nonwoven substrate, in accordance with a second exemplary embodiment of the invention.

FIG. 3 shows a cross-sectional view of two bicomponent fibers, in accordance with the second exemplary embodiment of the invention.

FIG. 4 shows a microscale side view of a nonwoven substrate, in accordance with a third exemplary embodiment of the invention.

FIG. 5 shows a cross-sectional view of two polyphenylene sulfide fibers in accordance with the third exemplary embodiment of the invention.

FIG. 6 shows a cross-sectional view of a polyphenylene sulfide fiber, in accordance with a fourth exemplary embodiment of the invention.

FIG. 7 shows a cross-sectional view of a trilobal polyphenylene sulfide fiber in accordance with a fifth exemplary embodiment of the invention.

FIG. 8 shows a flow chart illustrating a method of providing a substrate in accordance with the first exemplary embodiment of the present invention.

### DETAILED DESCRIPTION

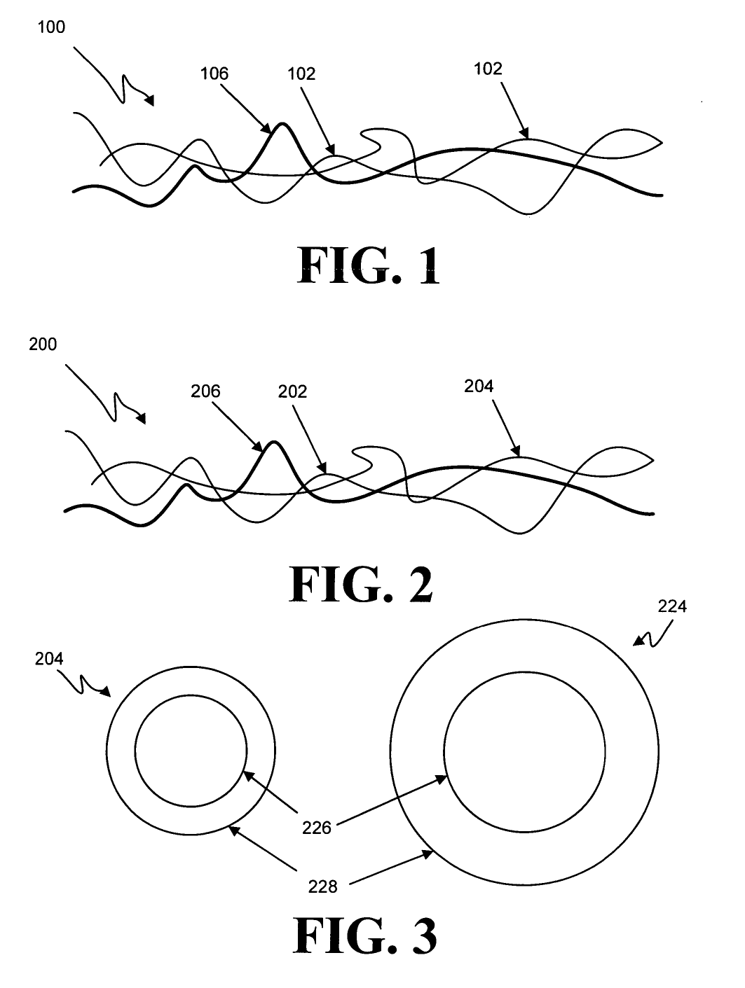

FIG. 1 illustrates a microscale side view of a nonwoven substrate 100, in accordance with a first exemplary embodiment of the invention. The nonwoven substrate 100 is made up of staple fibers 102 substantially homogeneously mixed with binder fibers 106. The nonwoven substrate 100 has staple fibers 102 at a minimum of 5 wt. % and binder fibers 106 at a minimum of 5 wt. %. The binder fiber 106 includes polyphenylene sulfide (hereinafter, PPS). The staple fibers 102 may be substantially drawn or tensioned while binder fiber 106 may be substantially undrawn or untensioned. Drawing or tensioning fiber is an activity familiar to one having ordinary skill in the art.

The nonwoven substrate 100 is made up of at least 5 wt. % of staple fibers 102 and at least 5 wt. % of binder fiber 106 substantially homogeneously mixed with the staple fibers 102. As an example, the nonwoven substrate 100 could be made up of at least 15 wt. % of staple fibers 102 and at least 15 wt. % of binder fibers 106. As a still further example, the nonwoven substrate 100 may be made up of at least 30 wt. % of staple fibers 102 and at least 20 wt. % of binder fibers. The nonwoven substrate 100, for further example, may be made up of approximately 60 wt. % of staple fibers 102 and approximately 40 wt. % binder fibers 106. While FIG. 1 shows two staple fibers 102 to one binder fiber 106, the fiber count is substantially noncritical in comparison to the percentage of the fiber 102, 106 weights.

The dimensions of the staple fibers 102 and the binder fibers 106 may include a length of at least 0.25 inches. The dimensions of the staple fibers 102 and the binder fibers 106 may include a length of at least 0.5 inches. The dimensions of the staple fibers 102 and the binder fibers 106 may include a length of approximately between 1.0 inch and 3.0 inches. The binder fibers 106 and the staple fibers 102 may have any of a variety of cross sections, as will be discussed further herein. The binder fibers 106 at least partially include PPS and may consist entirely of PPS.

The binder fiber 106 may have a melting temperature of at least 155 degrees Celsius. The binder fiber 106 may have a melting temperature of at least 180 degrees Celsius. Similarly, the staple fibers 102 of the nonwoven substrate 100 may have a melting temperature of at least 155 degrees Celsius. The staple fibers 102 of the nonwoven substrate 100 may have a melting temperature of at least 180 degrees Celsius. Further, the nonwoven substrate 100 may have a melting temperature of at least 155 degrees Celsius. The nonwoven substrate 100 may have a melting temperature of at least 180 degrees Celsius. The melting temperature of the fibers 102, 106, and the nonwoven substrate 100, and, thereby, their thermal resistivity, will depend at least partially on the materials used to construct the fibers 102, 106.

The staple fibers 102 could include one or more of many different materials, such as aramid, PPS, or other materials known by one having ordinary skill in the art. Aramid and PPS are known to have a melting temperature of at least 180 degrees Celsius. Materials having a greater thermal resistivity may be more useful for high temperature applications of the nonwoven substrate 100.

Denier is a property that varies depending on the fiber type. It is defined as the weight in grams of 9,000 meters of fiber. The current standard of denier is 0.05 grams per 450 meters. Here are the formulas for converting denier into microns, mils, or decitex: Diameter in microns=11.89×(denier/density in grams per millilter)^{1/2}. The staple fiber 102 may be larger than 0.25 deniers. The binder fiber 106 may be larger than 0.25 deniers.

FIG. 2 shows a microscale side view of a nonwoven substrate 200 in accordance with a second exemplary embodiment of the invention. The nonwoven substrate 200 is made up of a first set of staple fibers 202 and a bi-component set of staple fibers 204 substantially homogeneously mixed with a set of binder fibers 206. The nonwoven substrate 200 has staple fibers 202, 204 collectively at a minimum of 5 percent by weight (wt. %) and binder fibers 206 at a minimum of 5 wt. %. The binder fibers 206 include PPS. The staple fibers 202, 204 may be substantially drawn or tensioned while binder fibers 106 may be substantially undrawn or untensioned.

The nonwoven substrate 200, for instance, may be made up of at least 15 wt. % of the first staple fiber 202, at least 15 wt. % of the bi-component set of staple fibers 204, and at least 20 wt. % of binder fiber 206. The nonwoven substrate 200, for instance, may be made up of 30 wt. % of the first staple fiber 202, 30 wt. % of the bi-component set of staple fibers 204, and 40 wt. % of binder fiber 206. The first set of staple fibers 202 could include one or more of many different materials, such as PPS, aramid, or other materials known by one having ordinary skill in the art.

The dimensions of the staple fibers 202, 204 and the binder fibers 206 may include a length of at least 0.125 inches. The dimensions of the staple fibers 202, 204 and the binder fibers 206 may include a length of approximately between 1.0 inches and 3.0 inches. The binder fibers 206 may have any of a variety of cross sections, as will be discussed further herein. The binder fibers 206 at least partially include PPS and may consist entirely of PPS.

The binder fiber 206 may have a melting temperature of at least 155 degrees Celsius and, further, a melting point of at least 180 degrees Celsius. Similarly, the staple fibers 202, 204 of the nonwoven substrate 200 may have a melting temperature of at least 155 degrees Celsius. The staple fibers 202, 204 of the nonwoven substrate 200 may have a melting temperature of at least 155 degrees Celsius. Further, the nonwoven substrate 200 may have a melting temperature of at least 155 degrees Celsius and, further, a melting point of at least 180 degrees Celsius.

FIG. 3 shows a cross-sectional view of two bi-component fibers, 204, 224, in accordance with the second exemplary embodiment of the invention. The two bi-component fibers 204, 224 include a substantially tensioned or drawn bi-component fiber, the bi-component staple fiber 204 and a substantially untensioned or undrawn bi-component fiber, a bi-component binder fiber 224. As a result of being drawn, the bi-component staple fiber 204 has a smaller radius than the bi-component binder fiber 224 in FIG. 3, which presumes the bi-component staple fiber 204 had a similar radius to the bi-component binder fiber 224 before being drawn or tensioned during manufacture. Both bi-component fibers 204, 224 include a first fiber element 228 including PPS and a second fiber element 226 encapsulated by the first fiber element 228. The second fiber element 226 may be a polymeric material. Polymeric materials are known to those having ordinary skill in the art, including polypropylene, polyester, nylon, and aramid. Other polymeric materials known to those having ordinary skill in the art are also considered to be within the scope of the invention.

The bi-component staple fiber 204 may have a melting temperature of at least 155 degrees Celsius and, further, a melting point of at least 180 degrees Celsius. The bi-component binder fiber 224 may have a melting temperature of at least 155 degrees Celsius and, further, a melting point of at least 180 degrees Celsius. The process of manufacturing a bi-component fiber 204, 224 may result in a fiber 204, 224 having a greater thermal resistivity than the elements 226, 228 of the fiber. As a result, the bi-component fiber 204, 224 may have a higher melting point than either of the fiber elements 226, 228. The bi-component staple fiber 204 may be larger than 0.25 deniers. The bi-component binder fiber 224 may be larger than 0.25 deniers.

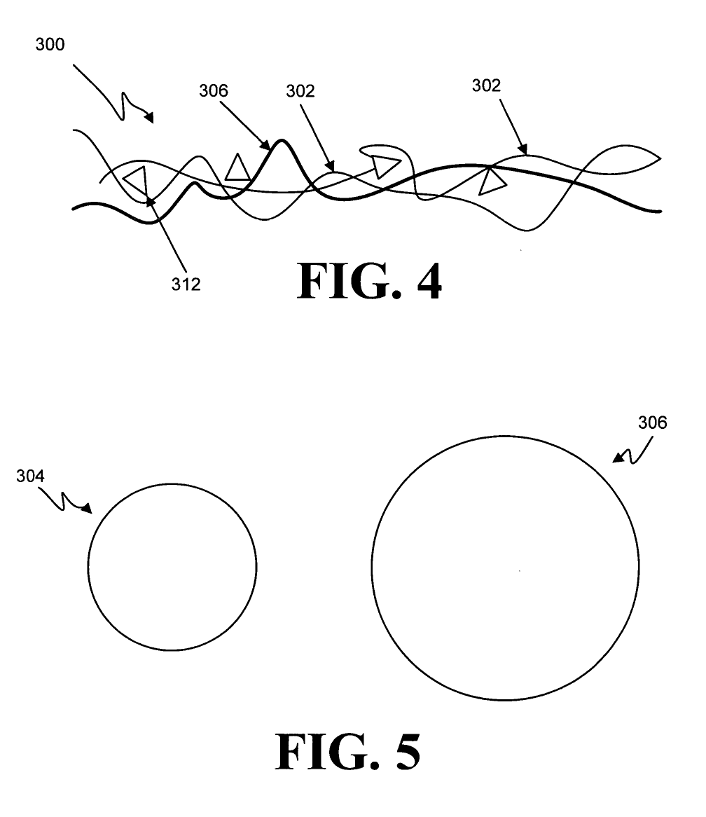

FIG. 4 shows a microscale side view of a nonwoven substrate 300, in accordance with a third exemplary embodiment of the invention. The nonwoven substrate 300 includes a substantially tensioned PPS fiber 302 substantially homogeneously mixed with a substantially untensioned PPS fiber 306. The substantially tensioned PPS fiber 302 is a staple fiber and the substantially untensioned PPS fiber 306 is a binder fiber. The nonwoven substrate 300 has the substantially tensioned PPS fiber 302 at a minimum of 5 wt. % and the substantially untensioned PPS fiber 306 at a minimum of 5 wt. %. The nonwoven substrate 300 also includes a composite 312.

The composite 312 may be provided such that the composite 312 mixes with the fibers 302, 306 to form the nonwoven substrate 300. The composite 312 may include, for example, PPS film, glass, or a polymeric substrate. The composite 312 may be mixed with the fibers 302, 306 to alter the material properties of the nonwoven substrate 300. The composite 312 may be used to make the nonwoven substrate 300 more thermally resistive, to give the nonwoven substrate 300 greater tensile strength, or in other ways known to those having ordinary skill in the art.

The nonwoven substrate 300 has at least the 5 wt. % of the substantially tensioned PPS fiber 302 substantially homogeneously mixed with at least the 5 wt. % of the substantially untensioned PPS fiber 306. As an example, the nonwoven substrate 300 could be made up of at least 15 wt. % of the substantially tensioned PPS fiber 302 and at least 15 wt. % of the substantially untensioned PPS fiber 306. As a still further example, the nonwoven substrate 300 may be made up of at least 30 wt. % of the substantially tensioned PPS fiber 302 and at least 20 wt. % of the substantially untensioned PPS fiber 306. The nonwoven substrate 300, for further example, may be made up of 60 wt. % of the substantially tensioned PPS fiber 302 and 40 wt. % of the substantially untensioned PPS fiber 306.

The dimensions of the substantially tensioned PPS fiber 302 and the substantially untensioned PPS fiber 306 may include a length of at least 0.25 inches. The dimensions of the substantially tensioned PPS fiber 302 and the substantially untensioned PPS fiber 306 may include a length of approximately between 1.0 inch and 3.0 inches. The substantially untensioned PPS fiber 306 may have any of a variety of cross-sections, as will be discussed further herein. The substantially untensioned PPS fiber 306 may be combined with other binder fibers or may be the only binder fiber in the nonwoven substrate 300. The substantially tensioned PPS fiber 302 may have any of a variety of cross-sections, as will be discussed further herein. The substantially tensioned PPS fiber 302 may be combined with other staple fibers or may be the only staple fiber in the nonwoven substrate 300.

The substantially untensioned PPS fiber 306 may have a melting temperature of at least 155 degrees Celsius and, further, a melting point of at least 180 degrees Celsius. Similarly, the substantially tensioned PPS fiber 302 of the nonwoven substrate 300 may have a melting temperature of at least 155 degrees Celsius and, further, a melting point of at least 180 degrees Celsius. Further, the nonwoven substrate 300 may have a melting temperature of at least 155 degrees Celsius and, further, a melting point of at least 180 degrees Celsius. The substantially untensioned PPS fiber 306 may be larger than 0.25 deniers. The substantially tensioned PPS fiber 302 may be larger than 0.25 deniers.

FIG. 5 shows a cross-sectional view of a substantially tensioned PPS fiber 302 and a substantially untensioned PPS fiber 306 according to the third exemplary embodiment of the nonwoven substrate 300. The diameter of the substantially untensioned PPS fiber 306, as shown, may be larger than that of the substantially tensioned PPS fiber 302 as a PPS fiber will suffer a reduction in cross-sectional area when it is substantially tensioned.

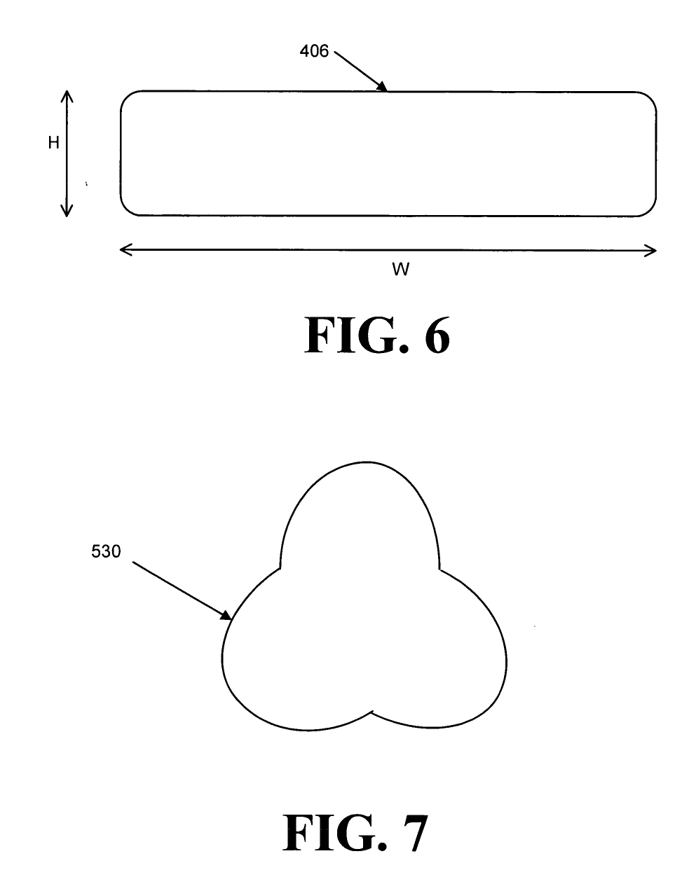

FIG. 6 shows a cross-sectional view of a flat PPS fiber 406, in accordance with a fourth exemplary embodiment of the invention. The flat PPS fiber 406, for example, may be used as a staple or binder fiber in a nonwoven substrate, such as those described herein. The flat PPS fiber 406 is an example of a PPS fiber that has a non-standard cross-section or, more specifically, a non-circular cross-section. The flat PPS fiber 406 has a height H and a width W that is at least twice the height H. The flat PPS fiber 406 may have a melting temperature of at least 155 degrees Celsius. A nonwoven substrate that uses the flat PPS fiber 406 as a staple or binder may have significantly less air permeability through the substrate than a similar nonwoven substrate using a PPS fiber having a circular cross-section, such as substantially untensioned PPS fiber 306 of FIG. 5. If the nonwoven substrate is utilized as an insulator or filter, for instance, the reduced permeability of the flat PPS fiber structure 406 may mean that less fiber, by weight, is required to make the nonwoven substrate of higher performance with the flat PPS fiber 406 as compared to a PPS fiber having a circular cross-section.

FIG. 7 shows a cross-sectional view of a trilobal PPS fiber 530, in accordance with a fifth exemplary embodiment of the invention. The trilobal PPS fiber 530 may find application as a staple fiber or a binder fiber. The variation in cross-section creates a different relationship between the fibers in a nonwoven substrate as compared to standard, circular cross-section fibers. The trilobal cross-section may allow the trilobal PPS fiber 530 to become intermingled more advantageously, particularly if the a substrate sheet of trilobal PPS fiber 530 is calendared. The denser intermingling may limit the passage of fluids, gasses, or electricity through a nonwoven substrate containing the trilobal PPS fiber 530. If the nonwoven substrate is utilized as an insulator or filter, for instance, the reduced permeability of the trilobal PPS fiber 530 may mean that less fiber, by weight, is required to make the nonwoven substrate with the trilobal PPS fiber 530 as compared to a PPS fiber having a circular cross-section.

Alternatively, a non-calendared or lightly calendared substrate sheet of trilobal PPS fiber may have fibers that do not intermingle particularly closely. By not intermingling closely, fluids, gasses or electricity may have larger channels through which to pass within the substrate sheet. This variation in channel size may be useful, for instance, when less fine materials are to be filtered from fluids and gasses. Similarly, there may be other electrical applications for this type of substrate sheet.

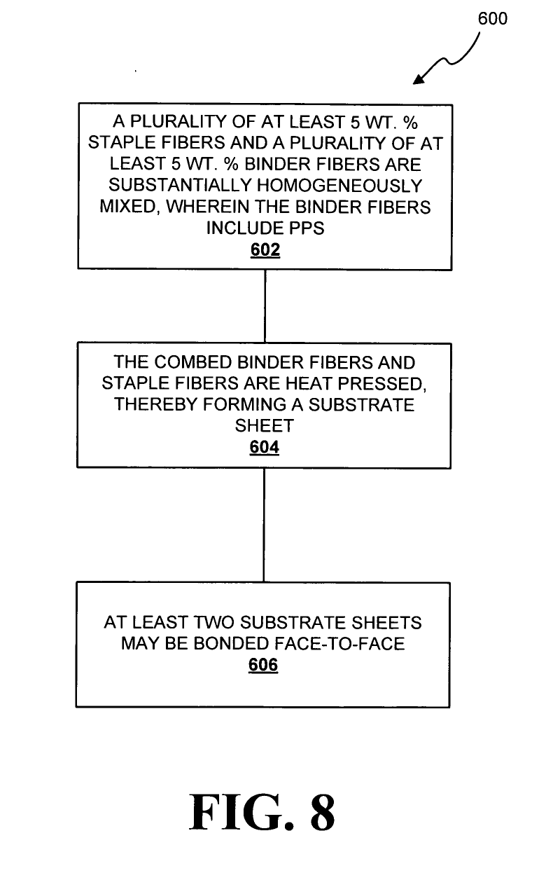

FIG. 8 is a flowchart illustrating a method 600 of providing a nonwoven substrate 100, in accordance with the first exemplary embodiment of the invention. It should be noted that any process descriptions or blocks in flow charts should be understood as representing modules, segments, portions of code, or steps that include one or more instructions for implementing specific logical functions in the process, and alternate implementations are included within the scope of the present invention in which functions may be executed out of order from that shown or discussed, including substantially concurrently or in reverse order, depending on the functionality involved, as would be understood by persons having an ordinary skill in the art of the present invention.

As is shown by block 602 in FIG. 8, a plurality of at least 5 wt. % staple fibers 102 and a plurality of at least 5 wt. % binder fibers 106 are substantially homogeneously mixed, wherein the binder fibers 106 include PPS. The plurality of staple fibers 102 and the plurality of binder fibers 106 may be dry when mixed. Mixing may be performed, for instance, by unidirectionally combing the plurality of staple fibers 102 and the plurality of binder fibers 106 together. The combed binder fibers 106 and staple fibers 102 are heat pressed, thereby forming a substrate sheet 100 (block 604).

As is shown in block 606, at least two substrate sheets 100 may be bonded face-to-face. Bonding the substrate sheets face-to-face may be performed where a thicker substrate is desired. The substrate sheet 100 may also be calendared. Calendaring the substrate sheet 100 will press the substrate sheet 100 into a thinner and broader sheet. Calendaring the substrate sheet 100 increases the density of the substrate sheet 100, which decreases the porosity of the substrate sheet 100. Decreasing the porosity of the substrate sheet 100 increases its insulative properties with regards to electrical applications and allows the substrate sheet 100 to be used to filter finer particles.

A composite may be added such that the composite mixes with the fibers 102, 106 and is heat pressed with the fibers 102, 106 to form the substrate sheet 100. The composite may include, for example, PPS film, glass, or a polymeric substrate. The composite may be mixed with the fibers 102, 106 to alter the material properties of the substrate sheet 100.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A nonwoven substrate comprising: at least 5 wt. % of staple fibers; and
at least 5 wt. % of binder fibers substantially homogeneously mixed with the staple fibers, wherein the binder fibers include polyphenylene sulfide.

2. The nonwoven substrate of claim 1, wherein the binder fibers consist of polyphenylene sulfide.

3. The nonwoven substrate of claim 1, wherein the binder fibers further comprise a bi-component fiber formed by a first fiber element and a second fiber element and wherein the first fiber element is polyphenylene sulfide.

4. The nonwoven substrate of claim 3, wherein at least one of the staple fibers and the binder fibers further comprise a denier of at least 0.25.

5. The nonwoven substrate of claim 3, wherein the second fiber element is polymeric.

6. The nonwoven substrate of claim 1, wherein the staple fibers further comprise a flat polyphenylene sulfide fiber, whereby the flat polyphenylene sulfide fiber has a height and a width that is at least twice the height.

7. The nonwoven substrate of claim 1, wherein at least one of the staple fibers and the binder fibers further comprise a trilobal polyphenylene sulfide fiber.

8. The nonwoven substrate of claim 1, wherein the staple fibers consist of polyphenylene sulfide.

9. The nonwoven substrate of claim 1, further comprising at least 15 wt. % of staple fibers and at least 15 wt. % of binder fibers.

10. The nonwoven substrate of claim 1, further comprising:
at least 15 wt. % of staple fibers, the staple fibers further comprising:
a bi-component fiber formed by a first fiber element and a second fiber element and wherein the first fiber element is polyphenylene sulfide;
a flat polyphenylene sulfide fiber, whereby the flat polyphenylene sulfide fiber has a height and a width that is at least twice the height; and
at least 15 wt. % of binder fibers, the binder fibers further comprising the bi-component fiber.

11. The nonwoven substrate of claim 1, wherein the staple fibers and the binder fibers are each at least 0.25 inches in length.

12. The nonwoven substrate of claim 1, wherein the binder fibers further comprise:
a first fiber element;
a second fiber element encapsulated by the first fiber element; and
wherein the first fiber element is polyphenylene sulfide.

13. The nonwoven substrate of claim 1, wherein the binder fibers have a melting temperature of at least 155 degrees Celsius.

14. The nonwoven substrate of claim 1, further comprising a composite mixed with the staple fibers and the binder fibers.

15. A method of providing a nonwoven substrate, comprising the steps of:
substantially homogeneously mixing a plurality of at least 5 wt. % staple fibers and a plurality of at least 5 wt. % binder fibers, wherein the binder fibers include polyphenylene sulfide; and
heat pressing the combed binder fibers and staple fibers, thereby forming a substrate sheet.

16. The method of claim 15, further comprising bonding at least two substrate sheets face-to-face.

17. The method of claim 15, further comprising calendaring the substrate sheet.

18. The method of claim 15, wherein the step of substantially homogeneously mixing further comprises substantially homogeneously mixing the plurality of at least 5 wt. % staple fibers, the plurality of at least 5 wt. % binder fibers and a composite.

19. The method of claim 15, wherein the step of substantially homogeneously mixing further comprises combing the plurality of at least 5 wt. % staple fibers and the plurality of at least 5 wt. % binder fibers unidirectionally.

20. The method of claim 15, wherein the step of substantially homogeneously mixing further comprises substantially homogeneously mixing a plurality of at least 5 wt. %, substantially dry staple fibers and a plurality of at least 5 wt. %, substantially dry binder fibers.
